(19) United States
(12) Patent Application Publication
(10) Pub. No.: US 2016/0078352 A1
(43) Pub. Date: Mar. 17, 2016

(54) AUTOMATED GENERATION OF INSIGHTS FOR EVENTS OF INTEREST

(71) Applicant: PAUL PALLATH, Bangalore (IN)

(72) Inventor: PAUL PALLATH, Bangalore (IN)

(21) Appl. No.: 14/483,411

(22) Filed: Sep. 11, 2014

(51) Int. Cl. G06N 5/04; G06N 7/00; G06T 11/60

(52) U.S. Cl. CPC G06N 5/046; G06T 11/60; G06N 7/005

(57) ABSTRACT

A dataset for an event of interest is received. The dataset represents occurrences of events including data corresponding to features. Event frame sizes are determined to generate insights on the dataset. Features from the occurrences of events are extracted corresponding to the determined event frame sizes. The extracted features are represented as feature abbreviations corresponding to a context. The feature abbreviations with high frequency of occurrence are identified. Rules are generated based on the identified feature abbreviations. Weights are associated to the feature abbreviations variably. Here, the association of weights is based on frequency of occurrence of feature abbreviations in the rules. The features corresponding to feature abbreviations are displayed as insights on the dataset. The displayed features correspond to a high probability of occurrence of the event of interest.

### BACKGROUND

In sport events such as cricket, tennis, etc., and in business scenarios such as recruitment, employee behavior, employee attrition pattern in an organization, etc., data collection happens over a substantial period of time, and the data collected is usually in a high range, e.g., of terabytes or petabytes. Data collected includes data both at a macro level and at a granular level. Though granular level data is collected, typically, this granular level data appears as an information overload due to lack of efficient analysis. Analyzing such ranges of terabytes or petabytes of granular level data and deriving useful insights is challenging.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. Various embodiments, together with their advantages, may be best understood from the following detailed description taken in conjunction with the accompanying drawings.

FIG. 1 is a block diagram illustrating an example environment for generation of insights based on events of interest, according to one embodiment.

FIG. 2 is illustrates a filtered dataset for an event of interest ‘wicket’, according to one embodiment.

FIG. 3 illustrates a list of features and feature abbreviations for a sport namely cricket, according to one embodiment.

FIG. 4 illustrates a list of feature abbreviations determined corresponding to an event of interest, according to one embodiment.

FIG. 5 illustrates a list of rules generated based on a list of feature abbreviations determined corresponding to an event of interest, according to one embodiment.

FIG. 6 illustrates identifying redundant rules from a list of generated rules, according to one embodiment.

FIG. 7 is a list of non-redundant rules illustrating assignment of weights for feature abbreviations, according to one embodiment.

FIG. 8 is illustrating a user interface of a data analytics application, providing a tag cloud display corresponding to weights assigned to feature abbreviations, according to one embodiment.

FIG. 9 is illustrating a user interface, providing a detailed display of rules, according to one embodiment, according to one embodiment.

FIG. 10 is a flow diagram illustrating a process of automated generation of insights for events of interest, according to one embodiment.

FIG. 11 is a flow diagram illustrating a process of automated generation of insights for employee attrition in an organization, according to one embodiment.

FIG. 12 is a flow diagram illustrating a process of automated generation of insights for an entity, according to one embodiment.

FIG. 13 is a block diagram illustrating an exemplary computer system, according to one embodiment.

### DETAILED DESCRIPTION

Embodiments of techniques for automated generation of insights for events of interest are described herein. In the following description, numerous specific details are set forth to provide a thorough understanding of the embodiments. A person of ordinary skill in the relevant art will recognize, however, that the embodiments can be practiced without one or more of the specific details, or with other methods, components, materials, etc. In some instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

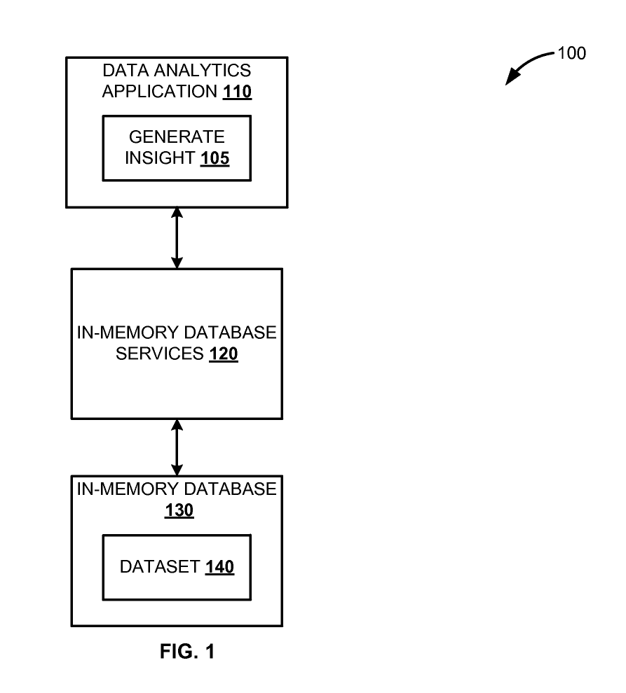

FIG. 1 is a block diagram illustrating example environment 100 for generation of insights based on events of interest, according to one embodiment. The environment 100 as shown contains data analytics application 110, in-memory database services 120 and in-memory database 130. Merely for illustration, only representative number and types of systems are shown in FIG. 1. Other environments may contain more instances of data analytics applications and in-memory databases, both in number and type, depending on the purpose for which the environment is designed.

Any event of interest can be selected and a request for insight generation can be triggered using ‘generate insight’ 105 option. ‘Generate insight’ option is merely exemplary, depending on a context or type of application, this option may vary. When the ‘generate insight’ 105 option in data analytics application 110 is selected/activated, an automatic request to in-memory database 130 is sent for performing data analytics operations on dataset 140 available in the in-memory database 130. This data analytics operation results in automated generation of insights for the event of interest. Insights generated may be visually represented in various graphical representations such as a tag cloud, bar chart, graph, etc., using which end user or analysts can infer useful insights/patterns. A connection is established from the data analytics application 110 to the in-memory database 130 via in-memory database services 120. The connectivity between the data analytics application 110 and the in-memory database services 120, and the connectivity between the in-memory database services 120 and the in-memory database 130 may be implemented using any standard protocols such as Transmission Control Protocol (TCP) and/or Internet Protocol (IP), etc.

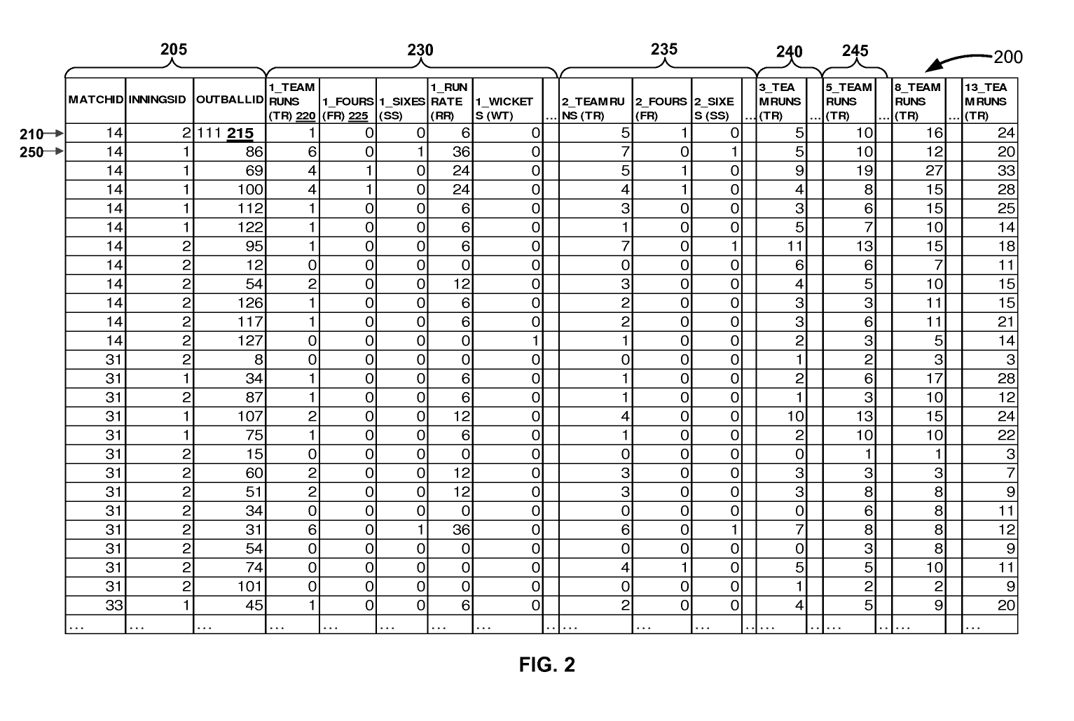

For example, consider a sport namely cricket, where a team of players representing a specific country, play a series of matches such as test matches, one day internationals, etc. Typically, for such a sport, data aggregators are involved in compiling information from detailed disparate databases on individual matches referred to as time series data. Time series data is a sequence of data points measured typically at successive points in time at a uniform time interval. For the sport cricket, time series data is received from a data aggregator which includes granular level data corresponding to matches played by a team over the past years. Consider an event of interest namely ‘wicket’, accordingly the time series data is filtered for the event of interest ‘wicket’, and organized as a filtered dataset. A filtered dataset is a subset of master or complete dataset, where any filtering criteria can be applied on the master or complete dataset. Data organization in the filtered dataset is explained below in FIG. 2.

FIG. 2 illustrates filtered dataset 200 for an event of interest ‘wicket’, according to one embodiment. A ball being played in a specific cricket match, in a specific inning may have various features or parameters and derived features such as ‘strike rate’, ‘dot ball’, ‘speed of ball’, ‘extras’, ‘fours’, ‘sixes’, etc., associated with a bowler, batsman, field, etc. There can be any number of features and derived features not limited to the list noted above. In the filtered dataset 200, ‘matchid’, ‘inningsid’ and ‘outballid’ represents context as shown in 205. Individual occurrences of events 210, 250, etc., for the event of interest ‘wicket’ is listed in dataset 200. These individual occurrences of events have data corresponding to various features such as ‘team runs’, ‘fours’, ‘sixes’, ‘strike rate’, ‘run rate’, etc. An event frame size is used to determine aggregate data for various individual features associated with the event of occurrences within the event frame size. For example, for an event frame size of ‘n’ balls prior, aggregate data for various individual features associated with the event of occurrences within ‘n’ balls prior is determined. The event frame size corresponding to ‘n’ balls prior is determined using arithmetic series such as Fibonacci series. For example, based on the Fibonacci series, Fibonacci numbers 1, 1, 2, 3, 5, 8, 13, 21, 34, 55, 89, 144, etc., are used to determine frame sizes as 1, 2, 3, 5, 8, 13, 21, 34, 55, 89 and 144. The number of frame sizes can be user defined and can be of any size. In the example considered, an event of interest ‘wicket’ has occurred in the ‘match id’ ‘14’, ‘innings id’ ‘2’ and ‘outballid’ ‘111’ as shown in a row 210. This occurrence of event has data corresponding to various features. Based on the event frame size of ‘n’ balls prior to the ‘outballid’ ‘111’ 215, i.e., 1, 2, 3, 5, 8 and 13, aggregate of various individual features are determined.

The features are shown suffixed with the event frame size, for example, for an event frame size ‘1’, the feature ‘teamruns’ is represented as ‘1_teamruns’ as shown in 220, the feature ‘fours’ is represented as ‘1_fours’ as shown in 225, etc. For the event frame size ‘1’, various features ‘1’ ball prior to the event occurrence ‘outballid’ ‘111’ is shown in 230. ‘1’ ball prior to the ‘outballid’ ‘111’, team runs represented as ‘1_teamruns’ 220 is ‘1’, ‘1’ ball prior to the ‘outballid’ ‘111’, fours represented as ‘1_Fours’ 225 is ‘0’, etc. Similarly, features corresponding to event occurrences for event frame size ‘2’ is determined as shown in 235, features corresponding to event occurrences for event frame size ‘3’ is determined as shown in 240, features corresponding to event occurrences for event frame size ‘5’ is determined as shown in 245, etc. Similarly, for the event of interest ‘wicket’ in the context ‘match id’ ‘14’, ‘innings id’ ‘1’ and ‘outballid’ ‘86’, the event of occurrence along with the features are shown in a row 250.

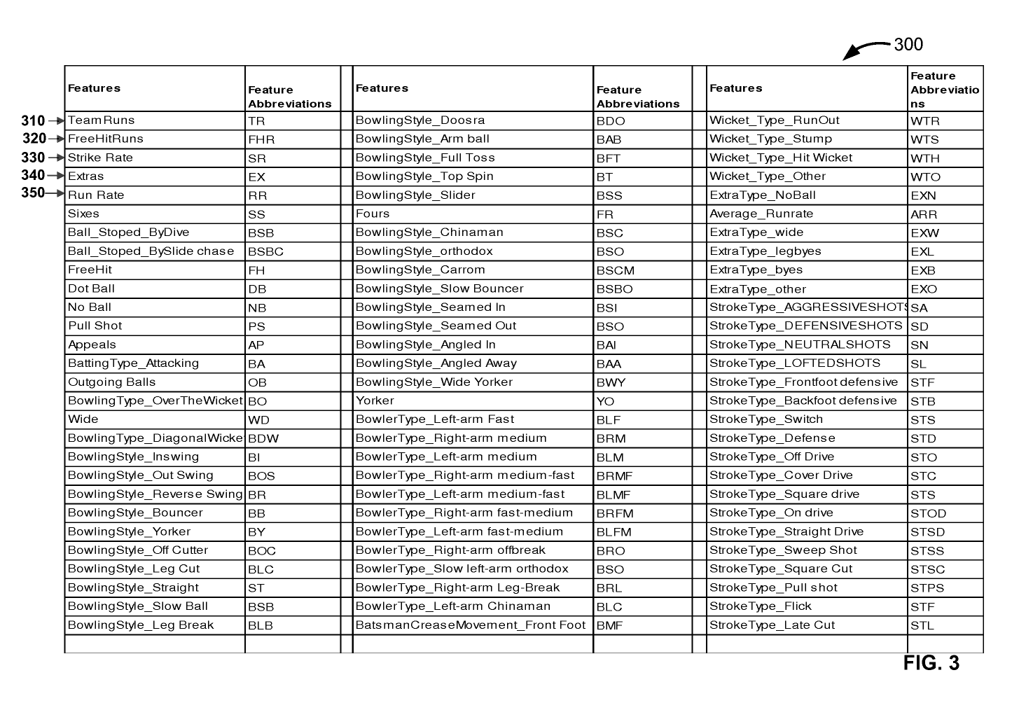

FIG. 3 illustrates list 300 of features and feature abbreviations for a sport namely cricket, according to one embodiment. For example, feature ‘teamruns’ has a feature abbreviation ‘TR’ as shown in 310, the feature ‘freehitruns’ has a feature abbreviation ‘FHR’ as shown in 320, the feature ‘strike rate’ has a feature abbreviation ‘SR’ as shown in 330, the feature ‘Extras’ has a feature abbreviation ‘EX’ as shown in 340, etc. Similarly, the features and feature abbreviations are stored in a table for lookup by the data analytics application. In one embodiment, the features and feature abbreviations can be stored in a hash table, dictionary table, etc., for lookup. This list of features and feature abbreviations is merely exemplary, depending on the sport or context there can be different sets of features and feature abbreviations.

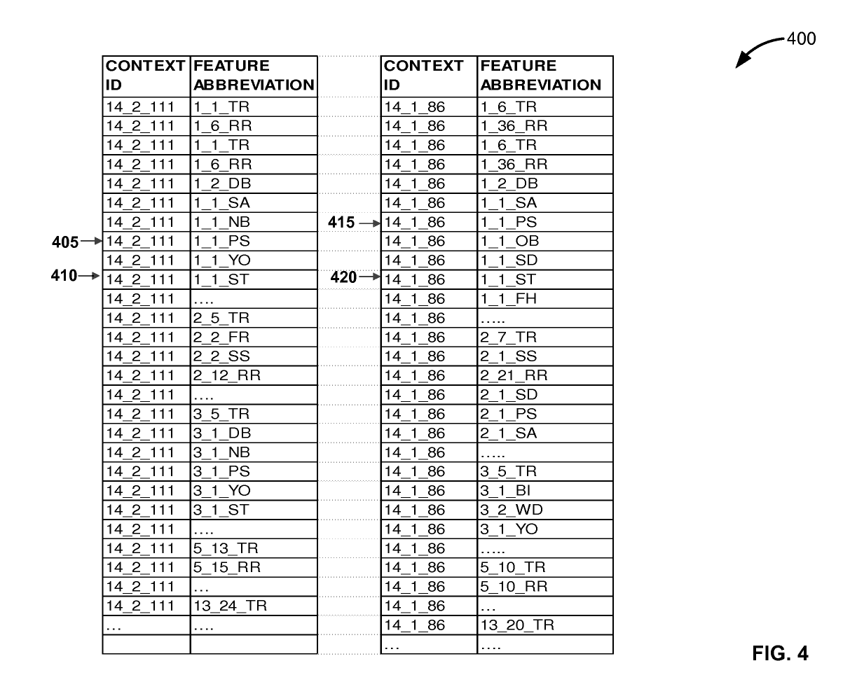

FIG. 4 illustrates a list of feature abbreviations determined corresponding to an event of interest, according to one embodiment. The list 400 of feature abbreviations is determined from the filtered dataset 200 of event occurrences with various features for the event of interest ‘wicket’ shown in FIG. 2. Consider row 210 of FIG. 2, the context ‘match id’ ‘14’, ‘innings id’ ‘2’ and ‘outballid’ ‘111’ is represented as a context ID (context identifier) ‘14_{—}2_{—}111’. The feature team runs ‘1_teamruns’ 220 is ‘1’ and this is represented as a feature abbreviation ‘1_{—}1_TR’ where first number ‘1’ represents event frame size, second number ‘1’ represents runs scored by the team, and the feature abbreviation for ‘team runs’ is looked up in 310 of the list 300 in FIG. 3, and identified as ‘TR’. Similarly, feature abbreviation for the next feature ‘1_runrate’ is represented as ‘1_{—}6_RR’ where first number ‘1’ represents event frame size, second number ‘6’ represents run rate, and the feature abbreviation for ‘runrate’ is looked up in 350 of the list 300 in FIG. 3, and identified as ‘RR’. Feature abbreviations are listed for the event frame sizes 1, 2, 3, 5, 8 and 13 for the ‘context ID’ ‘14_{—}2_{—}111’. Similarly, feature abbreviations are listed for the event frame sizes 1, 2, 3, 5, 8 and 13 for the ‘context ID’ ‘14_{—}1_{—}86’. In this example, the features with a value of ‘0’ are not considered while determining feature abbreviations. However, if non-occurrence of a feature may be considered for a different event of interest then features with a value of ‘0’ can be considered. The identified feature abbreviations in list 400 are analyzed for determining rules.

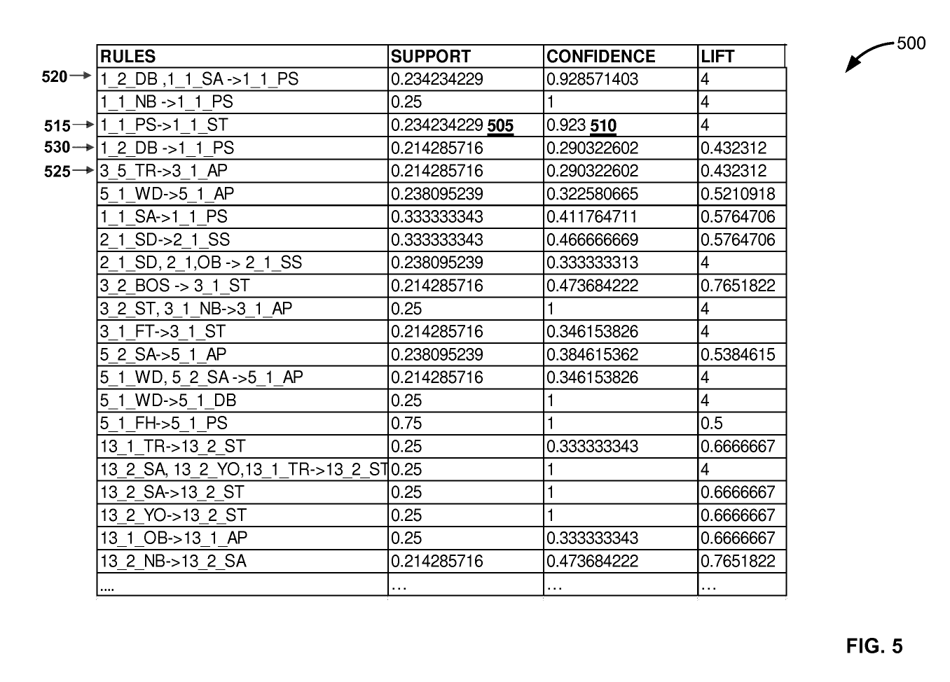

FIG. 5 illustrates list 500 of rules generated based on a list of feature abbreviations determined corresponding to an event of interest, according to one embodiment. Analysis is performed on the list 400 of feature abbreviations of FIG. 4, for discovering uncovered relationships based on the frequency of occurrence of individual feature abbreviations, and generating insights. The uncovered relationships can be represented in the form of rules. To generate rules, various data mining algorithms such as Apriori algorithm, DSM-FI, etc., can be used. In order to find frequent feature abbreviations, support and confidence of feature abbreviations are determined. The strength of a rule X->Y can be measured in terms of its support and confidence. Support determines frequency of occurrence of features X and Y appearing together in feature abbreviation in context ID (context identifier) in the dataset, while confidence determines how frequently Y appears in feature abbreviation that contains X.

For example, when Apriori algorithm is used, the frequent feature abbreviations are identified from the list 400 of feature abbreviations of FIG. 4. For example, consider feature abbreviations ‘1_{—}1_PS’ and ‘1_{—}1_ST’, both these feature abbreviations occurs in multiple context ID's as shown in 405, 410 and 415, 420, etc., of FIG. 4. Support could be calculated using a formula:

$$Support ( X \to Y ) = \frac{Count ( X ⋃ Y )}{N}$$

where X and Y may represent any feature abbreviations, count (X∪Y) represents a count where both feature abbreviations X and Y occur in individual context ID's, and N represents the total number of context ID's (identifiers) in the dataset. Support is calculated for the feature abbreviations ‘1_{—}1_PS->1_{—}1_ST’ using the above formula. Let count (1_{—}1_PS∪1_{—}1_ST) be 2300 and N be 10000, Support (1_{—}1_PS->1_{—}1_ST) is calculated as 2300/10000=0.234234229 shown in 505.

Confidence is calculated using a formula:

$$Confidence ( X \to Y ) = \frac{Count ( X ⋃ Y )}{Count ( X )}$$

where X and Y may represent any feature abbreviations, count (X∪Y) represents a count where both feature abbreviations X and Y occur in individual context ID's, and count (X) represents the count where feature abbreviation X occurs in individual context ID's. Confidence is calculated for the feature abbreviations ‘1_{—}1_PS->1_{—}1_ST’ using the above formula. Let count (1_{—}1_PS∪1_{—}1_ST) be 2300 and count (1_{—}1_PS) be 2492, Confidence (1_{—}1_PS->1_{—}1_ST) is calculated as 2300/2492=0.923 as shown in 510.

For finding rules, a value of minimum support and a value of minimum confidence are fixed to filter rules that have a support value and a confidence value greater than this minimum threshold. For example, minimum support value is determined or fixed as 0.2 and the minimum confidence value is determined or fixed as 0.2. The feature abbreviations having the minimum support value 0.2 are determined as frequent feature abbreviations. Feature abbreviations ‘1_{—}1_PS->1_{—}1_ST’ has a support value of 0.234234229 which is greater than the determined minimum support value of 0.2. Based on the determined frequent abbreviations, rules can be generated using Apriori algorithm. Using Apriori algorithm, a rule of the type X->Y is formed if the confidence of the rule X->Y is greater than the minimum confidence specified to filter the rules. In this example, based on Apriority algorithm, the feature abbreviations ‘1_{—}1_PS->1_{—}1_ST’ has a confidence value of 0.923 which satisfies the minimum confidence value criteria, and accordingly they are joined and generated as rule ‘1_{—}1_PS->1_{—}1_ST’ as shown in 515. Similarly, rules ‘1_{—}2_DB, 1_{—}1_SA->1_{—}1_PS’ 520, ‘1_{—}2_DB->1_{—}1_PS’ 530, ‘3_{—}5_TR->3_{—}1_AP’ 525, etc., are generated.

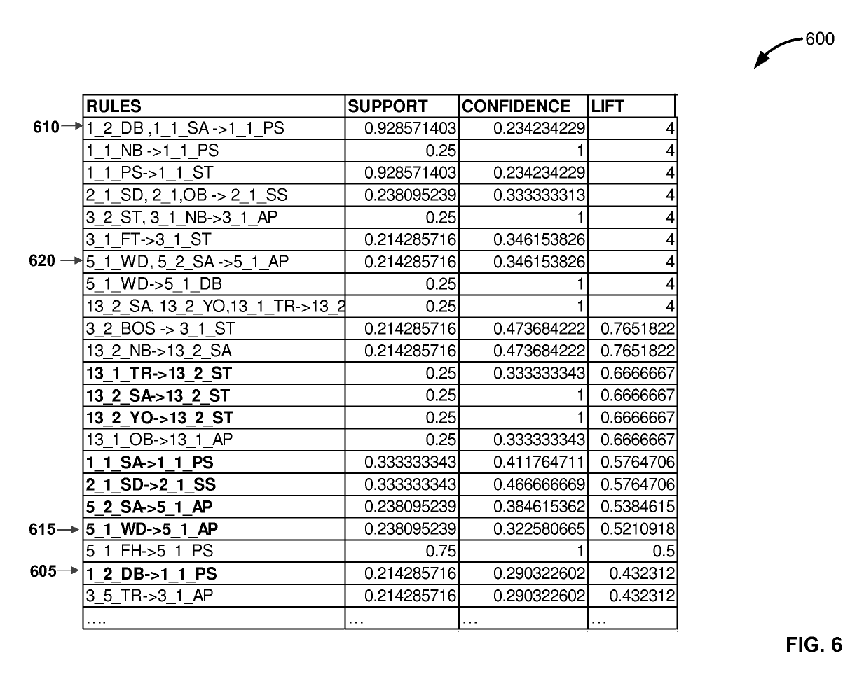

Lift value is computed for the generated rules. Lift value is a measure of performance of a rule at predicting. Lift value is computed using the formula:

$$Lift ( X \to Y ) = \frac{confidence ( X \to Y ) * N}{count ( Y )}$$

where confidence(X->Y) represents the confidence value calculated for the rule X->Y, N represents the total number of context ID's (identifiers) in the dataset, and count(Y) represents a count where feature abbreviation Y occur in individual context ID's. Let confidence(X->Y) be 0.923, N be 10000, and count (Y) be 2308. Lift (1_{—}1_PS->1_{—}1_ST) is calculated as 0.923*10000/2308=4. The generated rules may be sorted based on the lift values, and rules may be arranged in increasing order of lift values, as the lift values indicate measure of performance of rules at predicting. The sorted rules are shown in FIG. 6.

FIG. 6 illustrates identifying redundant rules from a list of generated and sorted rules, according to one embodiment. List 600 of generated and sorted rules is parsed to identify redundant rules. Redundant rules which are a subset of a longer rule are identified and eliminated. Rule ‘1_{—}2_DB->1_{—}1_PS’ 605 is identified as a redundant rule of ‘1_{—}2_DB, 1_{—}1_SA->1_{—}1_PS’ 610. Accordingly, the redundant rule ‘1_{—}2_DB->1_{—}1_PS’ 605 is eliminated from the list 600. Rule ‘5_{—}1_WD->5_{—}1_AP’ 615 is identified as a redundant rule and a subset of rule ‘5_{—}1_WD, 5_{—}2_SA->5_{—}1_AP’ 620. Accordingly, the rule ‘5_{—}1_WD->5_{—}1_AP’ 615 is eliminated from the list 600. Similarly, the other redundant rules indicated in a pattern are eliminated from the list 600.

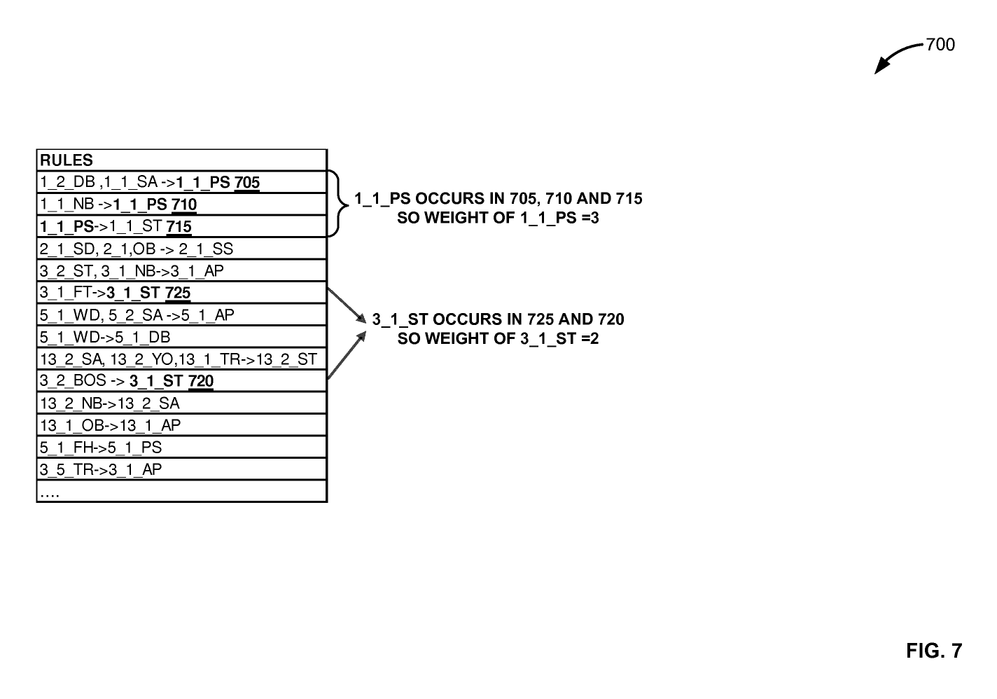

FIG. 7 is a list of non-redundant rules illustrating assignment of weights variably for feature abbreviations, according to one embodiment. List 700 shows the list of non-redundant rules. A number of occurrences of individual feature abbreviations in the rules list are determined. Weights are assigned variably to the feature abbreviations based on the number of occurrences of individual feature abbreviations in the rules list irrespective of the feature abbreviations occurring in antecedent or consequent of the rules. Consider feature abbreviation 1_{—}1_PS, this feature abbreviation occurs in rules ‘1_{—}2_DB, 1_{—}1_SA->1_{—}1_PS’ 705, ‘1_{—}1_NB->1_{—}1_PS’ 710, and ‘1_{—}1_PS->1_{—}1_ST’ 715. Feature abbreviation ‘1_{—}1_PS’ occurs three times in the list 700, and the weight assigned is ‘3’. Consider another feature abbreviation ‘3_{—}1_ST’, this feature abbreviation occurs in rules ‘3_{—}2_BOS->3_{—}1_ST’ 720 and ‘3_{—}1_FT->3_{—}1_ST’ 725. Feature abbreviation ‘3_{—}1_ST’ occurs two times in the list 700, and the weight assigned is ‘2’. The feature abbreviation ‘1_{—}1_PS’ occurs three times so higher weight ‘3’ is assigned to this feature abbreviation in comparison to the feature abbreviation ‘3_{—}1_ST’ which occurs two times with a weight of ‘2’. Similarly, the number of occurrences of individual feature abbreviations in the list 700 is determined and weights are assigned variably based on the number of occurrences of individual feature abbreviations in the list 700.

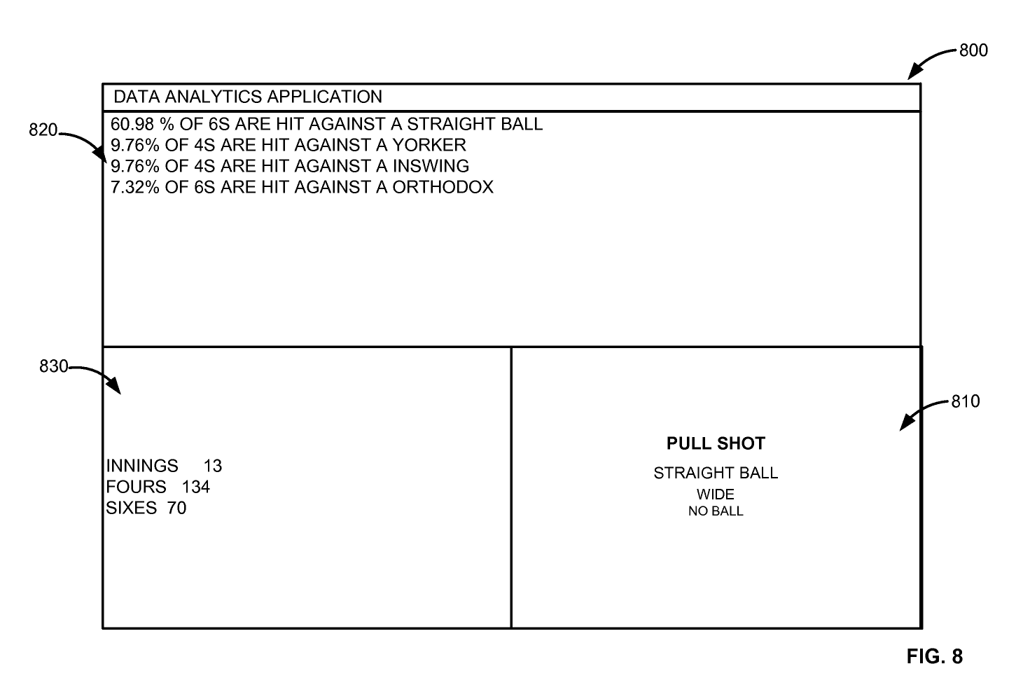

FIG. 8 is illustrating user interface 800 of a data analytics application, providing a tag cloud display corresponding to weights variably assigned to feature abbreviations, according to one embodiment. All the feature abbreviations are displayed in a tag cloud proportional to the weights of the feature abbreviations. In the list 700 of FIG. 7, some of the feature abbreviations are ‘1_{—}1_PS’, ‘3_{—}1_ST’, ‘5_{—}1_WD’, ‘1_{—}1_NB’, etc. The features corresponding to these feature abbreviations are looked up in the list 300 of features and feature abbreviations in FIG. 3. For example, the feature abbreviation ‘1_{—}1_PS’ is looked up in FIG. 3, and the corresponding feature is identified as ‘Pull shot’ and displayed in the tag cloud, and the suffix 1_{—}1 is ignored. In tag cloud the feature with maximum weight is displayed in a first large font, the feature with the next maximum weight is displayed in a second large font, etc., and the features with a minimum weight is displayed in smaller fonts. The assignment of font sizes is exponentially proportional to the weights. For example, weights 5, 4, 3, 2, and 1 can be mapped to font sizes 350%, 300%, 250%, 200% and 150%, respectively. The feature ‘Pull Shot’ is displayed in a third large font size of 250% since the weight assigned is ‘3’, feature ‘Straight’ ball is displayed in a fourth large font size of 200% since the weight assigned is ‘2’, feature ‘Wide’ and No Ball′ are displayed in a fifth large font size of 150% since weight assigned is ‘1’, etc., as shown in window 810. The displayed feature abbreviations indicate pressure points which lead to the occurrence of the event of interest ‘wicket’.

Based on the rules determined in list 700 of FIG. 7, various other insights can be generated such as percentage of sixes, fours, etc., hit against a particular type of ball. For example, from the filtered dataset and the rules formed, confidence of ‘sixes hit against a straight ball’ is computed as 0.6098. This is represented in percentage as 60.98% of sixes are hit against a straight ball′, ‘9.76% of sixes are hit against a Yorker’, etc., as shown in window 820. Additional statistics associated with the filtered dataset can be displayed in window 830 such as innings 13, fours 134, sixes 70, etc. In the above example, filtered dataset for the event of interest cricket was considered. The features with higher weight are displayed in a tag cloud as shown in 810. When the displayed features ‘pull shot, ‘straight ball’, ‘wide’ and a ‘no ball’ occur in a match there is a high probability of the occurrence of the event of interest ‘wicket’.

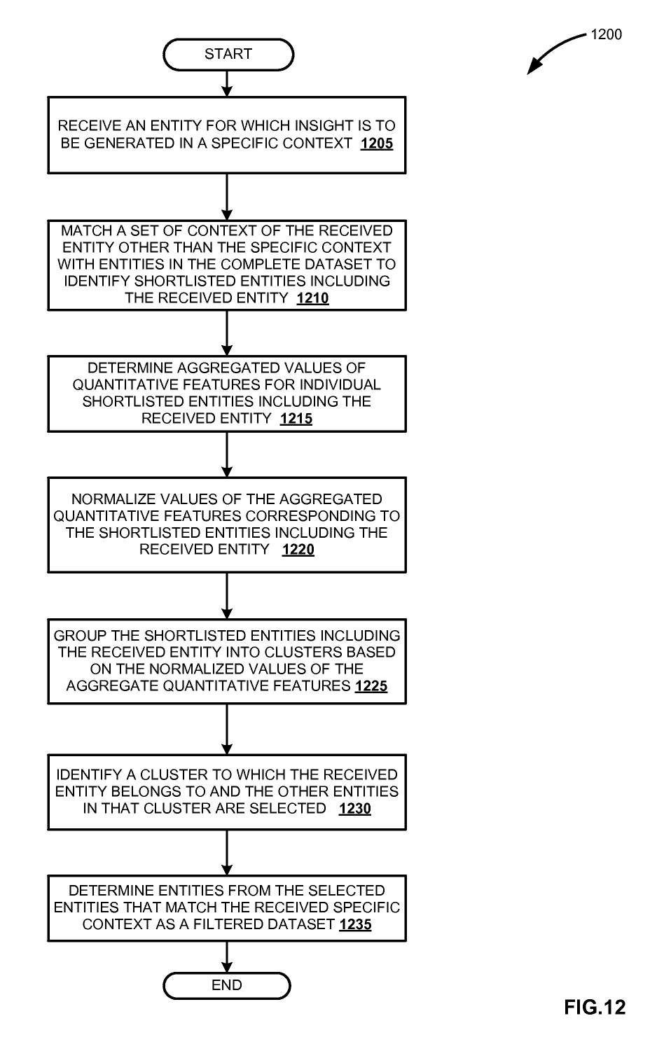

In one embodiment, to generate insights for an entity such as a new player in any of the contexts such as ground, team, country, bowler, etc., for which there is no prior data available, clustering technique is used to identify players similar to the new player and insights are generated on the identified similar players. The steps involved in identifying players similar to the new player are explained in FIG. 12 below. For example, consider a scenario of identifying similar players and generating insights for a new player ‘player A’ who has not played in ‘ground A’. Filtered dataset including occurrences of events are not available for the new player ‘player A’ in the context of ‘ground A’. Let ‘player A’ have a record of features such as number of test matches played as 30, number of one day matches played as 40, number of matches being not out as 5, number of ‘sixes’ scored as 40, etc. Players from the master or complete dataset similar or matching the record or set of features of ‘player A’ are identified as shortlisted players. Let ‘player S’, ‘player T’, ‘player W’, ‘player Q’, ‘player Z’ and ‘player 0’, etc., be few players among the shortlisted players. Aggregated values of various quantitative features from the set of features listed in 300 are derived for each shortlisted player including ‘player A’. Let the set of quantitative features derived for the data be represented as QF^{j=1 . . . k}, where k is the total number of quantitative features in the data. Clustering technique is applied on the normalized values of the aggregated quantitative feature of the shortlisted players including ‘player A’ to find players similar to ‘player A’. ‘Z score normalization is the normalization technique used for normalizing each quantitative feature QF^{j=1 . . . k} in the data. For example, let one of the quantitative feature QF¹ be ‘the number of sixes’ with values x₁, x₂, x₃ . . . xₘ each of the shortlisted players (where m is the total number of shortlisted players including ‘player A’). Let, x₁ represents the value of number of ‘sixes’ of ‘player A’, x₂ represents the value of number of ‘sixes’ of ‘player S’, etc.

‘Z score normalization’ is used to transform these values to normalized values using the formula:

$${Z}_{i} = \frac{{x}_{i} - μ}{σ}$$

where i=1 to m
Xᵢ=value of the ith player
   μ=Mean
σ=Standard deviation
   Values in the feature number of ‘sixes’ for shortlisted players are ‘Z score’ normalized using the equation above. Values x₁, x₂, x₃ . . . xₘ are used to compute mean (μ) and standard deviation (a) for the feature QF¹ ‘number of ‘sixes’. Z₁ is calculated using value X1, μ and σ. Similarly, Z₂ is calculated using value X2, μ and σ, Z₃ is calculated using value X3, μ and σ, etc. Each of the ‘k’ Quantitative Features ‘QF’ are normalized using the above method. Automated Machine Learning Clustering algorithm such as self-organizing map (SOM) is applied on the normalized quantitative feature values to identify logical groups or clusters among the shortlisted players. By using SOM algorithm the shortlisted players along with the new player ‘player A’ are grouped in various clusters such as C1, C2 . . . CN. Let ‘player S’, ‘player Q’, ‘player A’, ‘player 0’ be in cluster C2, and ‘player T’, ‘player W’, ‘player Z’ be in cluster C4, etc. To identify players similar to ‘player A’, determine the cluster to which ‘player A’ belongs. ‘Player A’ belongs to cluster C2, therefore other players in cluster C2 are identified to be players similar to ‘player A’. Players ‘player S’, ‘player Q’ and ‘player 0’ are the players similar to ‘player A’. From the identified similar players, players who have played on ‘ground A’ or players who match a requested context are determined. For these determined players feature abbreviations are determined as explained in FIG. 4, rules are generated as explained in FIG. 5, redundant rules are identified as explained in FIG. 6, weights are assigned to feature abbreviations as explained in FIG. 7, and the feature abbreviations indicating pressure points are displayed as explained in FIG. 8.

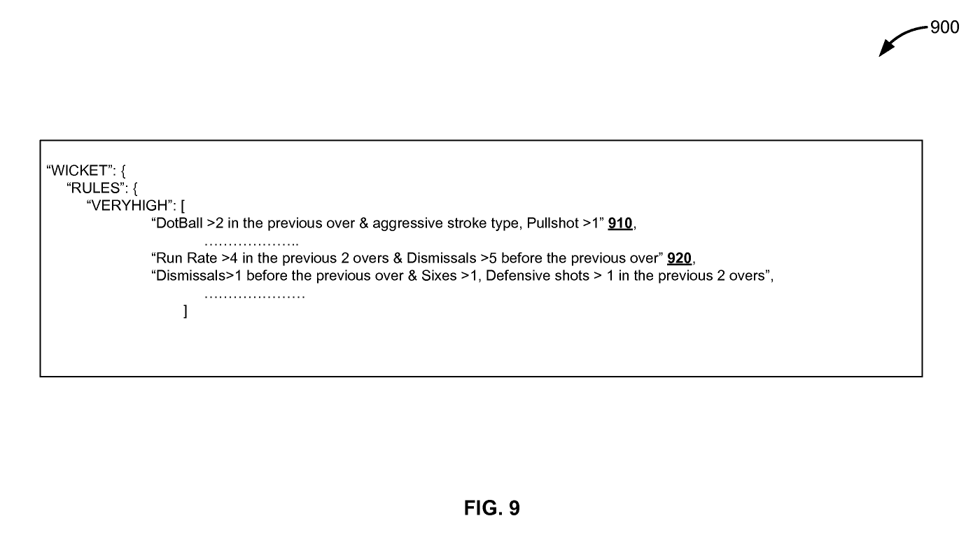

FIG. 9 is illustrating user interface 900, providing a detailed display of rules, according to one embodiment. This method of detailed display of rules enables an analyst to analyze and use this as an input to a different analysis module or a different output display system. The rules generated as shown in list 700 of FIG. 7 are displayed in detail in window 900. The rules with high lift values are displayed such as ‘DotBall >2 in the previous over & aggressive stroke type, Pullshot >1’ 910, ‘Run Rate >4 in the previous 2 overs & Dismissals >5 before the previous over’ 920, etc. These rules indicate a high probability of occurrence of the event of interest ‘wicket’. These rules are detailed which will enable an analyst to perform detailed analysis.

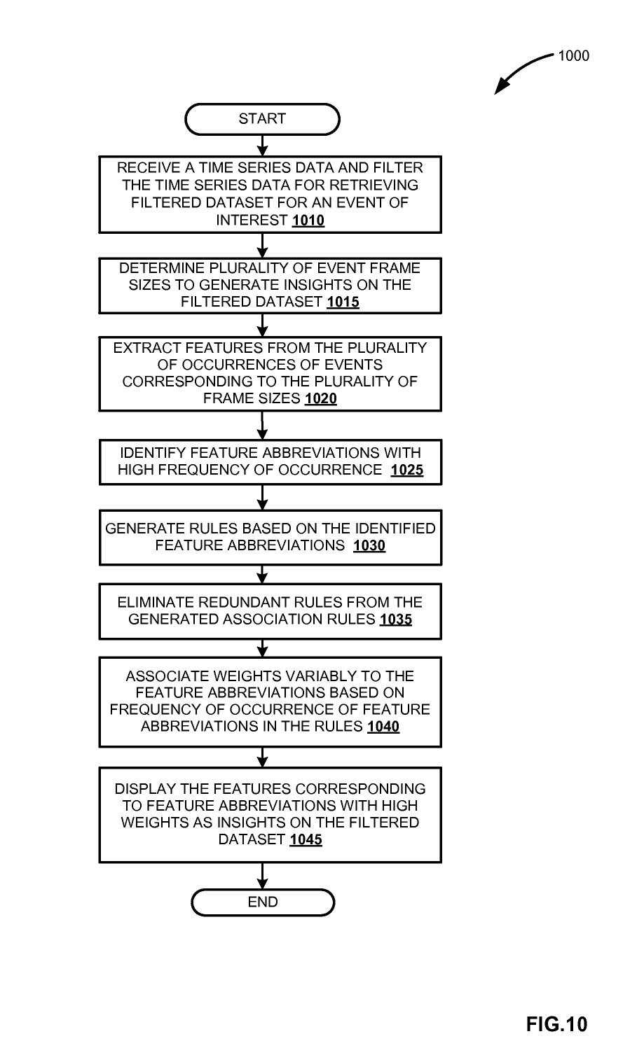

FIG. 10 is a flow diagram illustrating process 1000 of automated generation of insights for events of interest, according to one embodiment. At 1010, a time series data is received, and the time series data is filtered to retrieve a filtered dataset for an event of interest. At 1015, a number of event frame sizes are determined to generate insights on the filtered dataset. The individual occurrences of events have data corresponding to various features, where the features represent properties associated with the individual occurrences of events. An event frame size is used to determine aggregate data for various individual features associated with the event of occurrences within the event frame size. At 1020, features are extracted from the number of occurrences of events corresponding to the number of event frame sizes. The extracted features are represented as feature abbreviations corresponding to a context. At 1025, the feature abbreviations with high frequency of occurrence are identified. At 1030, based on the identified feature abbreviations, rules are generated. At 1035, redundant rules are identified and eliminated from the generated rules. At 1040, weights are associated to the feature abbreviations. Association of weights is based on frequency of occurrence of feature abbreviations in the rules. At 1045, the features corresponding to the feature abbreviations with high weights are displayed as insights on the filtered dataset. The displayed features correspond to a high probability of occurrence of the event of interest.

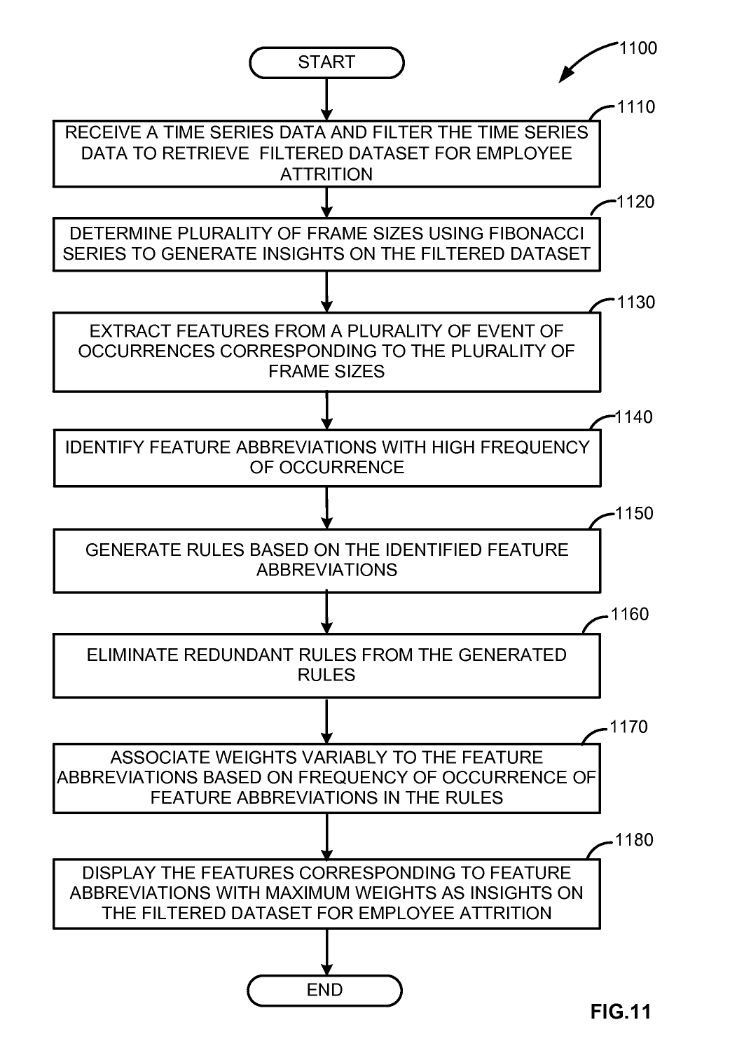

FIG. 11 is a flow diagram illustrating process 1100 of automated generation of insights for employee attrition in an organization, according to one embodiment. At 1110, a time series data associated with the organization is received. The time series data is filtered to retrieve a filtered dataset for employee attrition in an organization. For example, data associated with employees who have quit the organization is filtered as a filtered dataset for employee attrition. At 1120, a number of event frame sizes such as 1, 2, 3, etc., is determined using a mathematical series such as Fibonacci series to generate insights on the filtered dataset. For example, event frame sizes can be in months, such as number of employees who have quit the organization ‘1 month’ prior, ‘2 months’ prior, ‘3 months’ prior, etc. At 1130, features are extracted from the number of events of occurrences corresponding to the number of event frame sizes. For example, various features such as average productive time, goals for the month, etc., for an ‘employee A’ who has quit the organization ‘1 month’ prior is captured on a daily basis as event of occurrences.

The extracted features are represented as feature abbreviations corresponding to a context. Context may be department, business unit, etc., of the organization. At 1140, the feature abbreviations with high frequency of occurrence are identified. At 1150, rules are generated based on the identified feature abbreviations. At 1160, redundant rules are identified and eliminated from the rules generated. At 1170, weights are associated variably to the feature abbreviations. This association of weights variably is based on frequency of occurrence of feature abbreviations in the generated rules. At 1180, the features corresponding to the feature abbreviations with high weights are displayed as insights on the filtered dataset. The displayed features correspond to a high probability of occurrence of employee attrition.

FIG. 12 is a flow diagram illustrating process 1200 of automated generation of insights for an entity, according to one embodiment. Insights are generated for the entity for a specific context for which filtered dataset is not available. At 1205, an entity for which insights is to be generated in a specific context is received. At 1210, a set of context of the received entity other than the specific context is matched with entities in a complete dataset to identify shortlisted entities including the received entity. At 1215, aggregated values of quantitative features for individual shortlisted entities including the received entity are determined. At 1220, values of the aggregated quantitative features corresponding to the shortlisted entities including the received entity are normalized. At 1225, the shortlisted entities including the received entity are grouped into clusters based on the normalized values of the aggregated quantitative features. At 1230, a cluster to which the received entity belongs to is identified, and the other entities in that cluster are selected. At 1235, entities from the selected entities that match the received specific context are determined as a filtered dataset. For this filtered dataset with the matched entities insights are generated as shown in FIG. 4 to FIG. 8.

The various embodiments described above have a number of advantages. Enterprise data repositories have data in range of terabytes or petabytes, including data both at a micro level and macro level. When insights are generated on these micro level data, the information that appeared as an overload is now transformed to a useful insight identifying a new pattern or behavior. The insights can be generated for a variety of fields such as recruitment industry, manufacturing organizations, corporates, market research, etc. The factors that contribute to the occurrence of an event are captured efficiently. For example, based on the insights, pattern or trend of a player can be identified, strength and weakness of a player can be identified, behavior of an employee in a particular situation can be identified, etc. Even if there are no historic data, using clustering techniques a similar player or entity is identified and insights are generated on data associated with that player or entity.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (ASICs), programmable logic devices (PLDs) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

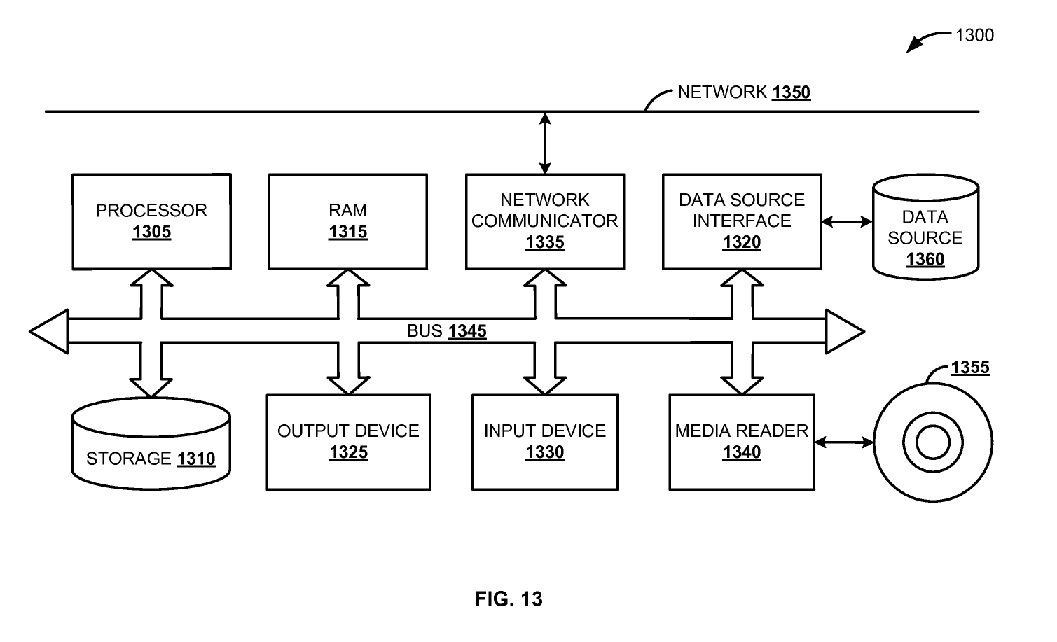

FIG. 13 is a block diagram of an exemplary computer system 1300. The computer system 1300 includes a processor 1305 that executes software instructions or code stored on a computer readable storage medium 1355 to perform the above-illustrated methods. The computer system 1300 includes a media reader 1340 to read the instructions from the computer readable storage medium 1355 and store the instructions in storage 1310 or in random access memory (RAM) 1315. The storage 1310 provides a large space for keeping static data where at least some instructions could be stored for later execution. The stored instructions may be further compiled to generate other representations of the instructions and dynamically stored in the RAM 1315. The processor 1305 reads instructions from the RAM 1315 and performs actions as instructed. According to one embodiment, the computer system 1300 further includes an output device 1325 (e.g., a display) to provide at least some of the results of the execution as output including, but not limited to, visual information to users and an input device 1330 to provide a user or another device with means for entering data and/or otherwise interact with the computer system 1300. Each of these output devices 1325 and input devices 1330 could be joined by one or more additional peripherals to further expand the capabilities of the computer system 1300. A network communicator 1335 may be provided to connect the computer system 1300 to a network 1350 and in turn to other devices connected to the network 1350 including other clients, servers, data stores, and interfaces, for instance. The modules of the computer system 1300 are interconnected via a bus 1345. Computer system 1300 includes a data source interface 1320 to access data source 1360. The data source 1360 can be accessed via one or more abstraction layers implemented in hardware or software. For example, the data source 1360 may be accessed by network 1350. In some embodiments the data source 1360 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A non-transitory computer-readable medium to store instructions, which when executed by a computer, cause the computer to perform operations comprising:
receive a dataset for an event of interest, wherein the dataset represents plurality of occurrences of events comprising data corresponding to features;
determine plurality of event frame sizes to generate insights on the dataset;
extract features from the plurality of occurrences of events corresponding to the plurality of event frame sizes, wherein the extracted features are represented as feature abbreviations corresponding to a context;
identify feature abbreviations with high frequency of occurrence;
generate rules based on the identified feature abbreviations;
associate weights variably to the feature abbreviations, wherein the association of weights is based on frequency of occurrence of feature abbreviations in the rules; and
display the features corresponding to feature abbreviations with high weights as insights on the dataset, wherein the displayed features correspond to a high probability of occurrence of the event of interest.

2. The computer-readable medium of claim 1, further comprising instructions which when executed by the computer further causes the computer to:
compute lift values corresponding to the generated rules; and
sort the generated rules in increasing order of lift values.

3. The computer-readable medium of claim 2, wherein the lift values are computed based on support values and confidence values of the generated rules.

4. The computer-readable medium of claim 1, wherein the dataset is a filtered dataset retrieved from a time series data.

5. The computer-readable medium of claim 1, further comprising instructions which when executed by the computer further causes the computer to:
identify redundant rules from the generated rules; and
eliminate the redundant rules.

6. The computer-readable medium of claim 1, wherein displaying the features further causes the computer to:
display the features corresponding to feature abbreviations in a tag cloud, wherein the features with high weights are displayed in large fonts.

7. The computer-readable medium of claim 1, further comprising instructions which when executed by the computer further causes the computer to:
receive an entity for which insights is to be generated in a specific context;
match a set of context of the received entity other than the specific context with entities in the dataset to identify shortlisted entities including the received entity;
determine aggregated values of quantitative features for the shortlisted entities including the received entity;
normalize values of the aggregated quantitative features corresponding to the shortlisted entities including the received entity;
group the shortlisted entities including the received entity into clusters based on the normalized values of the aggregated quantitative features;
identify a cluster to which the received entity belongs to and the other entities in that cluster are selected; and
determine entities from the selected entities that match the received specific context as a filtered dataset.

8. A computer-implemented method for automated generation of insights based on events of interest, the method comprising:
receiving a dataset for an event of interest, wherein the dataset represents plurality of occurrences of events comprising data corresponding to features;
determining plurality of event frame sizes to generate insights on the dataset;
extracting features from the plurality of occurrences of events corresponding to the plurality of event frame sizes, wherein the extracted features are represented as feature abbreviations corresponding to a context;
identifying feature abbreviations with high frequency of occurrence;
generating rules based on the identified feature abbreviations;
associating weights variably to the feature abbreviations, wherein the association of weights is based on frequency of occurrence of feature abbreviations in the rules; and
displaying the features corresponding to feature abbreviations with high weights as insights on the dataset, wherein the displayed features correspond to a high probability of occurrence of the event of interest.

9. The method of claim 8, further comprising instructions which when executed by the computer further causes the computer to:
computing lift values corresponding to the generated rules; and
sorting the generated rules in increasing order of lift values.

10. The method of claim 9, wherein the lift values are computed based on support values and confidence values of the generated rules.

11. The method of claim 8, wherein the dataset is a filtered dataset retrieved from a time series data.

12. The method of claim 8, further comprising instructions which when executed by the computer further causes the computer to:
identifying redundant rules from the generated rules; and
eliminating the redundant rules.

13. The method of claim 8, wherein displaying the features further causes the computer to:
displaying the features corresponding to feature abbreviations in a tag cloud, wherein the features with high weights are displayed in large fonts.

14. The method of claim 11, further comprising instructions which when executed by the computer further causes the computer to:
receiving an entity for which insights is to be generated in a specific context;
matching a set of context of the received entity other than the specific context with entities in the dataset to identify shortlisted entities including the received entity;
determining aggregated values of quantitative features for the shortlisted entities including the received entity;
normalizing values of the aggregated quantitative features corresponding to the shortlisted entities including the received entity;
grouping the shortlisted entities including the received entity into clusters based on the normalized values of the aggregated quantitative features;
identifying a cluster to which the received entity belongs to and the other entities in that cluster are selected; and
determining entities from the selected entities that match the received specific context as a filtered dataset.

15. A computer system for automated generation of insights based on events of interest, comprising:
a computer memory to store program code; and
a processor to execute the program code to:
receive a dataset for an event of interest, wherein the dataset represents plurality of occurrences of events comprising data corresponding to features;
determine plurality of event frame sizes to generate insights on the dataset;
extract features from the plurality of occurrences of events corresponding to the plurality of event frame sizes, wherein the extracted features are represented as feature abbreviations corresponding to a context;
identify feature abbreviations with high frequency of occurrence;
generate rules based on the identified feature abbreviations;
associate weights variably to the feature abbreviations, wherein the association of weights is based on frequency of occurrence of feature abbreviations in the rules; and
display the features corresponding to feature abbreviations with high weights as insights on the dataset, wherein the displayed features correspond to a high probability of occurrence of the event of interest.

16. The system of claim 15, further comprising instructions which when executed by the computer further causes the computer to:
compute lift values corresponding to the generated rules; and
sort the generated rules in increasing order of lift values.

17. The system of claim 16, wherein the lift values are computed based on support values and confidence values of the generated rules.

18. The system of claim 15, wherein the dataset is a filtered dataset retrieved from a time series data.

19. The system of claim 15, further comprising instructions which when executed by the computer further causes the computer to:
identify redundant rules from the generated rules; and
eliminate the redundant rules.

20. The system of claim 18, further comprising instructions which when executed by the computer further causes the computer to:
receive an entity for which insights is to be generated in a specific context;
match a set of context of the received entity other than the specific context with entities in the dataset to identify shortlisted entities including the received entity;
determine aggregated values of quantitative features for the shortlisted entities including the received entity;
normalize values of the aggregated quantitative features corresponding to the shortlisted entities including the received entity;
group the shortlisted entities including the received entity into clusters based on the normalized values of the aggregated quantitative features;
identify a cluster to which the received entity belongs to and the other entities in that cluster are selected; and
determine entities from the selected entities that match the received specific context as a filtered dataset.
